(19) United States
(12) Patent Application Publication
(10) Pub. No.: US 2008/0131621 A1
(43) Pub. Date: Jun. 5, 2008

(54) METHOD FOR FUSING HARD CERAMIC-METALLIC LAYER ON A BRAKE ROTOR

(76) Inventors: Warran Boyd Lineton, Ann Arbor, MI (US); Myron Jeffrey Schmenk, Lambertville, MI (US); William J. Zdeblick, Ann Arbor, MI (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/566,824

(22) Filed: Dec. 5, 2006

(51) Int. Cl. B05D 3/06

(52) U.S. Cl. 427/556

(57) ABSTRACT

A fused ceramic-metallic surface is formed on a supporting rotor (12) substrate for enhancing the service life and/or braking effectiveness of a vehicular brake assembly (10). The ceramic-metallic layer is produced by spreading a precursor slurry (32) on the friction surfaces (20, 22) of the rotor (12). The slurry (32) is dried and then irradiated in specific zones or predetermined areas (30) using a high powered diode laser (42). A copper mask (34) acts as a template by providing openings (38) which correspond precisely in shape and location to the predetermined areas (30) to be fused. The mask (34) includes a reflective mirror surface (36) which reflects away laser energy from areas of the friction surface (20, 22) that are not intended to be fused. Finish grinding or machining may be required to obtain the desired tribological surface for engaging friction pads (18) carried in a caliper (16).

### CROSS REFERENCE TO RELATED APPLICATIONS

NONE.

### BACKGROUND OF THE INVENTION

1. Field of the Invention

The invention relates generally to a method for enhancing the braking effectiveness and service life of a vehicular brake rotor and, more specifically, toward an improved method of making a brake rotor by irradiating a ceramic-metallic slurry using a high-power laser beam in combination with a reflective mask.

2. Related Art

A rotor for a disc brake forms part of the vehicle braking system and rotates together with a wheel. The rotor has a pair of opposed friction surfaces against which brake pads are brought into contact to arrest rotation of the wheel. In many applications, the rotor section of the disc brake is ventilated between the friction surfaces to improve cooling characteristics by dissipating heat produced from friction during the braking process.

Traditionally, disc brake rotors have been manufactured from a cast iron material. Although cast iron is relatively inexpensive and exhibits many of the functional attributes required of this application, they do tend to wear out over time. At the end of their service life, the brake rotor must be either re-machined or else replaced. For light vehicle and ordinary consumer applications, re-machining or replacement of a cast iron brake rotor is expected and usually not an undue burden. However, on commercial, heavy duty, and public service vehicles, which are characterized by substantially higher miles driven in service and typically under harder conditions, rotor wear is much increased. For these types of vehicles, time spent in the repair shop carries a double price tag—not only the maintenance and repair costs per se, but also the loss of commercial usefulness because the vehicles are not available for service.

The prior art has sought after longer lasting brake rotors, especially for commercial, heavy duty, and public service applications, which will result in reduced repair time and maintenance costs. Along these lines, the prior art has proposed forming a more durable wear surface on the rotors. Examples may be found in U.S. Pat. No. 5,712,029 to Tsugawa, et al., issued Jan. 27, 1998. As described in the Tsugawa reference, particles of ceramic can be applied to an alloy substrate, i.e., the brake rotor, and then scanned with a laser to trap particles in an aluminum alloy matrix. The resulting surface is highly wear resistant.

Another example of a technique for enhancing the wear surface of a brake rotor may be found in U.S. Pat. No. 6,753,090 to Haug, et al., issued Jun. 22, 2004. The Haug patent teaches the method of forming a surface layer on a brake element by applying a ceramic layer using any conventional coating process, including painting techniques. The ceramic coating is then treated with laser irradiation in predetermined regions. During the thermal reaction, a transition layer forms containing intermetallic phases and ceramic phases securely joined to both the substrate and the ceramic layer to insure a very good bond. The substrate can be an aluminum alloy.

An added benefit from these prior art approaches is the ability to fabricate the rotor from materials that are softer and lighter than cast iron. For example, aluminum alloys, which are lighter in weight but softer than cast iron, can be used together with a surface treatment as described in these prior art references and thereby result in a vehicle weight reduction. Of course, alloys other than aluminum can be used to similar effect.

Although the prior art has shown interest in promising techniques for enhancing the braking effectiveness and service life of a vehicular brake rotor, effective techniques for treating specific areas of the rotor disc have remained somewhat elusive. Accordingly, there is a desire among those of skill in this field to advance the art and embrace new methods for treating the friction surfaces of a rotor disc so as to enhance their braking effectiveness and their service life.

### SUMMARY OF THE INVENTION AND ADVANTAGES

The invention provides a method for enhancing braking effectiveness and/or service life of a vehicular brake rotor comprising the steps of: forming an annular rotor disc from a metallic substrate, the rotor disc having inboard and outboard friction surfaces for engaging friction pads carried by a caliper, forming a ceramic-metallic slurry, spreading the slurry over at least a portion of one of the inboard and outboard surfaces, and fusing the slurry to the metallic substrate in a predetermined area of the rotor disc using a laser beam. Prior to the fusing step, the method also includes the step of covering at least a portion of the friction surface with a reflective mask having an opening therein corresponding to the predetermined area on the friction surface to be fused. And the fusing step further includes focusing a laser beam through the opening in the mask and toward the slurry exposed through the opening so that the mask reflects the laser beam away from the rotor disc in areas not to be fused.

The subject method, which includes a novel application using a reflective mask as a template to control the precise regions which are to be irradiated by the laser beam, represents an advancement in both precision and production throughput for this emerging technology. Specifically, a mask which includes at least one opening corresponding in shape and location to the predetermined area of the friction surface to be fused enables use of commercial laser beams, such as for example multi-kilowatt diode lasers that employ a line-shaped beam to scan over a wide area. As portions of the laser beam extend beyond the predetermined area to be fused, those portions are reflected away by the reflective mask; fusing is only permitted through the openings in the mask. Thus, the fused areas can be applied with precision, and the most efficient control path for the laser beam can be used without fear of irradiating unwanted areas of the rotor disc. In one example, the rotor disc can be rotated relative to the laser beam in much the same fashion as an old time phonograph record is turned on a platter. During this process, the laser beam, like the phonograph needle, is continuously directed onto the rotating disc, yet only those predetermined areas of the rotor disc are fused with the ceramic-metallic particles.

### BRIEF DESCRIPTION OF THE DRAWINGS

These and other features and advantages of the present invention will become more readily appreciated when considered in connection with the following detailed description and appended drawings, wherein:

FIG. 1 is a perspective view of a brake disc assembly wherein the disc rotor is treated in predetermined areas so as to enhance its braking effectiveness and service life;

FIG. 2 depicts a rotor disc in cross-section to which is applied a ceramic-metallic slurry as illustratively represented in a painting technique;

FIG. 3 is a top view of one exemplary embodiment of a mask according to the subject invention;

FIG. 4 is a cross-sectional view of a rotor having applied thereto a ceramic-metallic slurry and covered by a mask;

FIG. 5 is a cross-sectional view depicting a laser fusing step in which the laser beam is reflected away from the rotor disc in areas not intended to be fused;

FIG. 6 is a cross-sectional view as in FIG. 5 but illustrating the laser beam focusing through the opening in the mask so as to fuse the slurry to the metallic substrate in only the predetermined area of the rotor disc;

FIG. 7 is an enlarged fragmentary view illustrating the friction surface of a rotor disc after the slurry has been fused to both sides of the metallic substrate, resulting in a microstructure that is hard and well mixed between the substrate material, the ceramic, and the metallic components in the slurry; and

FIG. 8 is a flow chart depicting a series of steps carried out within the context of the subject invention.

### DETAILED DESCRIPTION OF THE PREFERRED EMBODIMENT

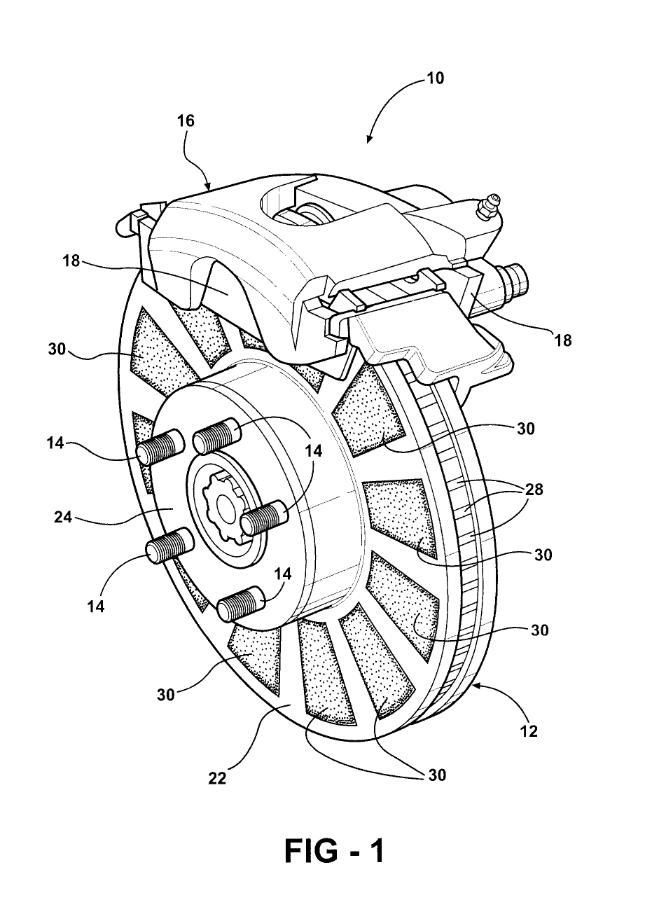

Referring to the figures, wherein like numerals indicate like or corresponding parts throughout the several views, a disc brake rotor assembly is generally shown at 10 in FIG. 1. The assembly 10 includes a rotor, generally indicated at 12, which is connected to an axle hub via lug bolts 14. A vehicle wheel, not shown, is attached over the lug bolts 14. A caliper, generally indicated at 16, carries a pair of friction brake pads 18 on opposite sides of the rotor 12. In response to hydraulic, pneumatic, electromechanical, or other actuating means activated by the vehicle operator, the friction pads 18 are squeezed into clamping contact with the opposing friction surfaces of the rotor 12 and thereby arrest rotation of the wheel.

The rotor 12 may be of the ventilated type including an annular inboard friction surface 20, which is centered about a central axis A. The central axis A is coincident with the rotational axis of the associated wheel. An annular outboard friction surface 22 is spaced from the inboard friction surface 20 and is also concentrically disposed about the central axis A. The inner edge of the outboard friction surface 22, i.e., proximal to the central axis A, adjoins a central hub section 24. The hub section 24 contains four or more lug bolt holes 26 for receiving the lug bolts 14 and fastening the rotor 12 to the wheel. A plurality of ribs 28 are disposed in the separation between the inboard 20 and outboard 22 friction surfaces. The ribs 28 may be distanced one from another in regular circumferential increments about the central axis A. Alternatively, the rib 28 spacing can be non-equal but in patterned arrangements. Alternatively still, the rotor 12 could be of the non-ventilated type, wherein the inboard and outboard friction surfaces represent but two sides of the same integral disc member.

According to the invention, the inboard 20 and outboard 22 friction surfaces of the rotor 12 are treated so as to enhance their braking effectiveness and/or their service life. This is accomplished by creating predetermined areas 30 on both the inboard 20 and outboard 22 friction surfaces that are substantially harder than the substrate material alone. Thus, whether the substrate material of the rotor 12 is the traditional cast iron, an aluminum alloy, a titanium alloy, or other metallic composition, the predetermined areas 30 represent regions or zones that rub against the friction pads 18 and resist degradation of the friction surfaces 20, 22 while also enhancing the braking effectiveness of the brake assembly 10. For illustrative purposes only, these predetermined areas 30 are depicted as radial stripes in FIG. 1. The radial stripes are but one example of a pattern that may be deemed effective for a particular brake assembly 10. Any other pattern or configuration for the predetermined areas 30 can be implemented using the techniques of this invention, including aesthetic patterns and vibration arresting patterns.

The methods of this invention include forming a rotor disc from a metallic substrate such as has been described herein above. This may be accomplished through a casting technique, a forging technique, or any other method by which rotor discs made from a metallic substrate can be formed. Also as stated previously, the metallic substrate may comprise the traditional cast iron or it may comprise an alloy of a lighter material, such as aluminum or titanium. Other metallic substrates and/or alloys can also be employed within the context of this invention.

The method also includes the step of forming a ceramic-metallic slurry 32. Preferably, this is accomplished by suspending both ceramic and metallic powders, together with a binder, in a liquid carrier. A preferred liquid carrier may comprise water, although other liquid carriers can be used. One example of a ceramic powder is titanium di-boride such as available from Alfa Aesar, a Johnson Matthey company. However, titanium di-boride (TiB₂) is not the only ceramic powder which may be used in carrying out this invention. Indeed, other ceramic powders include, but are not limited to: Al₂O₃, MgZrO₃, Cr₃C₂, WC, Cr₂O₃, TiO₂, TiC, B₄C, SiC, and Si₃N₄. Those of skill in the art will appreciate other ceramic powders which may also be useful in the context of this invention.

Together with the ceramic powders, metallic powders are also combined into the slurry 32. One example of a metallic powder which has been found to produce acceptable results in this invention is a cobalt alloy (CoNiCrAlY), known as Amdry 995C, Amdry 9951 or Amdry 9954 powers, available from the Sulzer Metco Company of Winterthur, Switzerland. Of course, this is not the only metallic powder which can be combined with a ceramic powder to produce a slurry 32 for use in this invention. Other metallic powders may include, but are not limited to combinations of the elements Cr, Co, Ni, Fe, Al, Mo, Y, Si, B and C. For example, and not in any way limiting, the metal combinations may include: NiCrAl, NiCr, Co, CoCr, CoCrNi, NiCrFeSiBC, Al, and CrMoCFe. Other metallic combinations and variations are also possible within the scope of this invention. Those with skill in the art will readily appreciate other metallic compositions and alloys which, combined with the ceramic powder, can be used to produce a slurry 32 useful in achieving the objectives of this invention.

The disclosed binder which is combined with the ceramic-metallic powders, together with the liquid carrier, may be selected from any of the known groups. One example of an acceptable binder is a polyvinyl alcohol (PVA) solution. In addition to the basic components of ceramic and metallic powders and binder in the liquid carrier, it is also possible to include a thickening agent, such as a carboxymethyl cellulose or gum material. Likewise, an antibacterial and/or antifungal agent may be included in the slurry 32. Once all of the ingredients are combined, they are mixed to form a homogenous slurry 32.

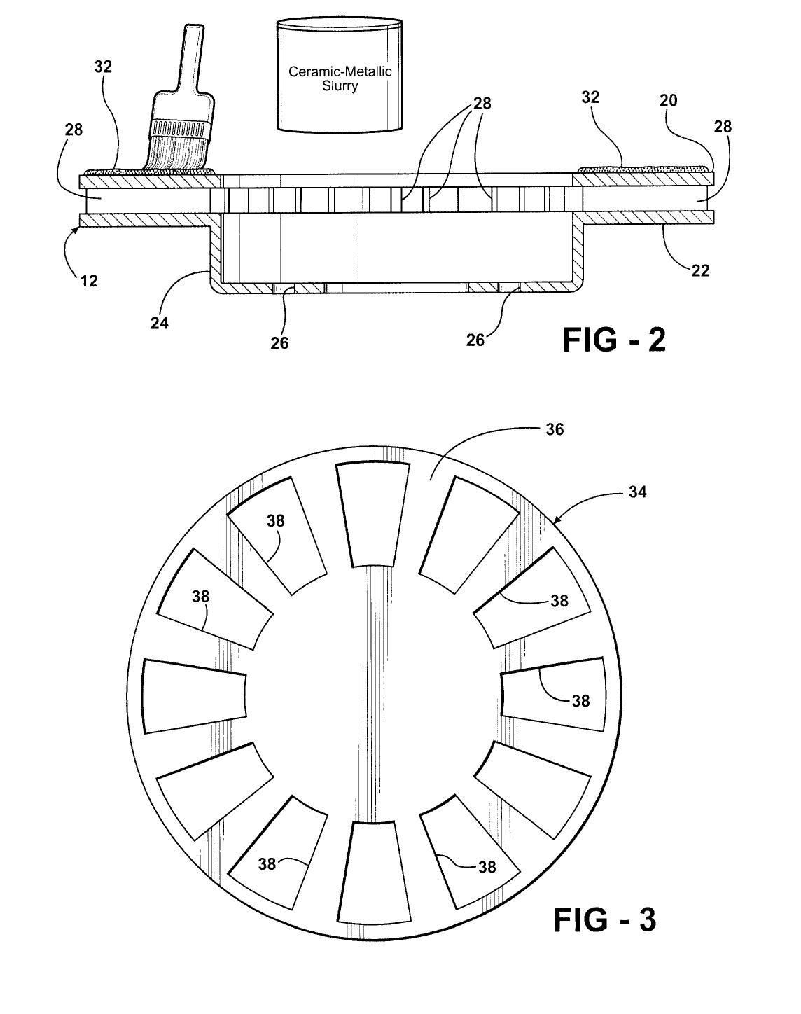

The slurry 32 is spread over at least a portion of the inboard 20 and/or outboard 22 frictional surfaces of the rotor 12. This can be accomplished in any practical manner. FIG. 2 illustratively depicts a painting technique which is one method by which the slurry may be applied. Other equally effective techniques may include screen printing the slurry 32 onto the rotor disc 12 or spraying the slurry 32 onto the rotor disc 12, or dipping the rotor disc 12 into a container of the slurry 32. Of course, different techniques may lend themselves to different styles of production and different degrees of efficiency. In general, any technique, including techniques other than those described here, may be deployed in the step of spreading the slurry onto the inboard 20 and outboard 22 surfaces of the rotor 12.

Once the slurry 32 s been spread over at least the portions which will later be fused to form the predetermined areas 30, a drying step is executed to drive off all or a substantial portion of the liquid carrier. The drying step can be accomplished using any known technique, including blowing hot air onto the rotor disc 12 or placing the rotor disc 12 into an oven. Other drying techniques may also be acceptable.

Referring now to FIGS. 3-6, a mask is generally indicated at 34. The mask 34 is shown for illustrative purposes in FIG. 3 as a generally circular member fabricated from a sheet-like copper material. Although copper is not the only material from which the mask 34 can be fabricated, it is a preferred material due to its high thermal conductivity and its ability to be polished to a mirror-like finish. Preferably, at least one surface 36 of the mask 34 is polished to a mirror-like finish for reasons to be described subsequently. At least one, but preferably a plurality, of openings 38 are formed in the mask 34 in equally spaced or otherwise patterned arrays. The openings 38 establish the template-like function of the mask 34 and complement precisely the predetermined areas 30 which will later form the enhanced surfaces for the rotor 12. Thus, in the example provided here in FIG. 1, wherein the predetermined areas 30 represent radial sections spaced equally about the friction surfaces 20, 22, the mask 34 is shown in FIG. 3 including corresponding openings 38 in the shape of radial segments spaced in equal circumferential increments. It bears reiterating again, however, that the number, shape, and spacing of the predetermined areas 30, together with the complementary openings 38, can take many different forms and will be dictated by the circumstances of each application.

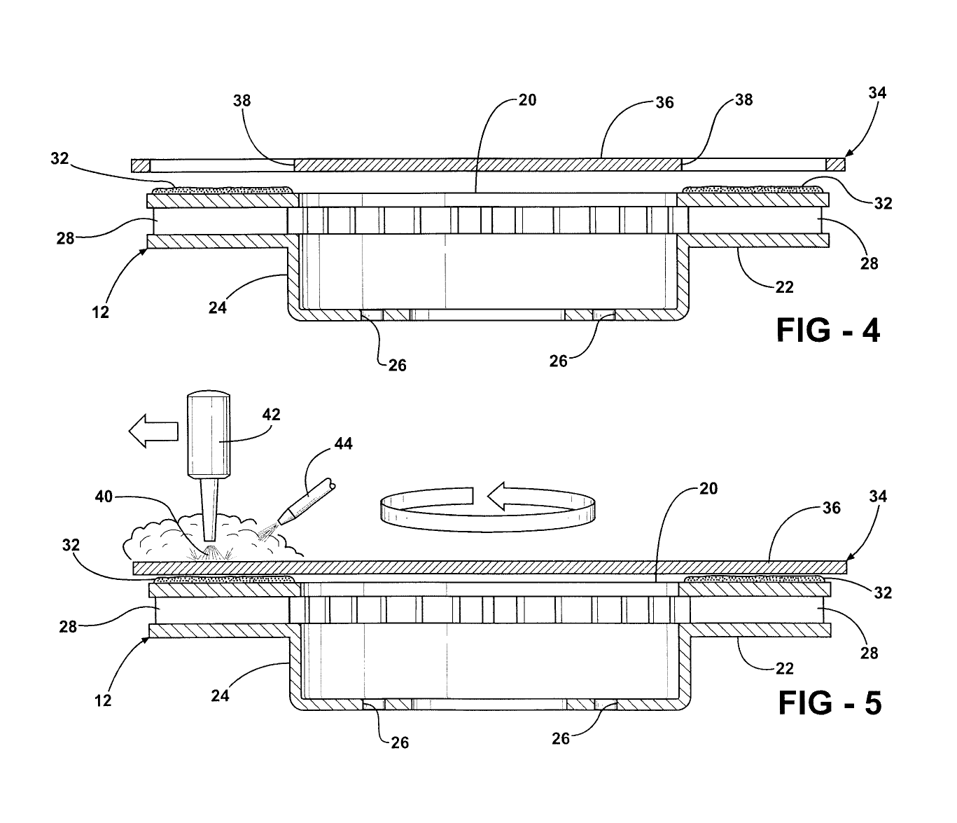

In FIG. 4, the mask 34 is shown covering the inboard friction surface 20, to which the slurry 32 has been applied and dried. Although FIG. 4 depicts a spacing between the mask 34 and the inboard friction surface 20, it is more likely that the mask 34 will lie in touching engagement or closely spaced with the rotor 12. The mirrored surface 36 of the mask 34 is presenting away from the rotor 12.

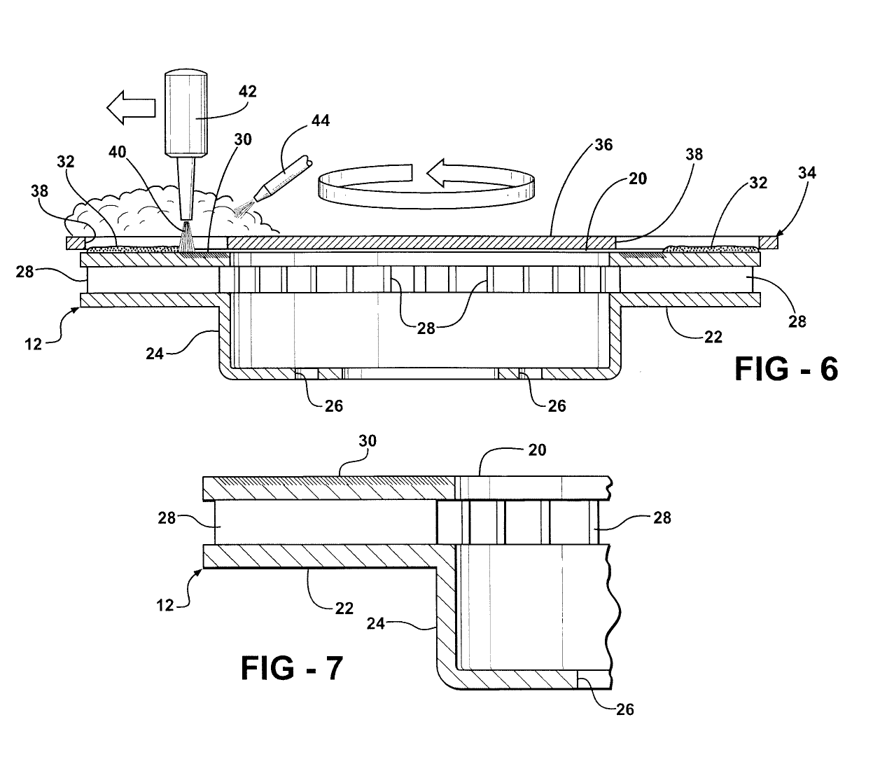

Referring now to FIGS. 5 and 6, the step of fusing the slurry 32 to the metallic substrate of the rotor 12 in a predetermined area 30 of the rotor disc 12 is depicted using a laser beam 40. The laser beam 40 is produced by a laser device 42 which is movably mounted relative to the rotor 12. In one embodiment of the invention, the rotor disc 12 may be mounted on a turntable with rotation centered about the central axis A. The laser 42 is mounted for linear movement in a radial direction relative to the central axis A. These movements are depicted by motion arrows in FIGS. 5 and 6. Thus, in something akin to the traditional phonographic record mounted on a turntable, where the rotating rotor 12 takes the form of a phonograph record; the laser device 42 is analogous to the needle. Of course, other techniques and strategies for producing relative motion between the laser beam 40 and the friction surfaces 20, 22 can be used instead of the one method described here.

As the rotor 12 is rotated, the laser 42 is energized so that its laser beam 40 projects toward the inboard friction surface 20. Whenever the laser beam 42 contacts the mirrored surface 36 of the mask 34, the laser beam 40 is reflected away from the rotor disc 12. The reflected segments correspond with areas that are not intended to be fused and transformed into the predetermined areas 30. And, because copper is such a good thermal conductor, any heat energy absorbed by the mask 34 from the laser beam 40 will be quickly dissipated through the body of the mask 34. However, as the laser beam 40 moves into the openings 38, the slurry 32 becomes fused under the intense energy of the laser beam 40 to produce the desired predetermined areas 30. This is illustrated in FIG. 6.

Through use of the mask 34, the laser 42 can be continually energized as its beam 40 shines across the entire inboard friction surface 20, yet only the predetermined areas 30 are fused. During fusing, the ceramic-metallic slurry, combined with the substrate material of the rotor 12, intermix and alloy themselves to produce fused, ceramic-metallic zones which resist wear and enable longer rotor life. In some cases, it may be desirable to envelope the predetermined areas 30 to be fused with a non-oxidizing shield gas. For example, argon can be used as a cover gas, flooding the fusing zone as through a nozzle 44 depicted in FIGS. 5 and 6.

Best results in connection with the fusing step have been accomplished using a high energy diode laser 42 with a line-shaped beam 40 capable of scanning a wide area. By high energy is meant preferably in excess of one kilowatt. Successful tests have been conducted using a four kilowatt Nuvonyx diode laser. Of course, those of skill may appreciate other laser types and other laser specifications which can be used effectively to accomplish the objectives of this invention.

FIG. 7 represents a cross-section through the rotor 12 in the region of a predetermined area 30 following the fusing step described above. The illustration here is intended to depict the transition layer which forms at and below the inboard friction surface 20 that contains intermetallic phases and ceramic phases securely joined to the substrate material, resulting in the finest of metallurgical bonds. As suggested above, the substrate material of the rotor 12 can be cast iron, aluminum alloy, a titanium alloy, or other appropriate material. Because the friction surfaces 20, 22 of a rotor 12 must be machined to an acceptable finish for in-service use, it may be necessary to perform a final machining or grinding operation to return the surface 20 to a specified condition. This machining operation may comprise grinding, cutting on a lathe, polishing, or other technique.

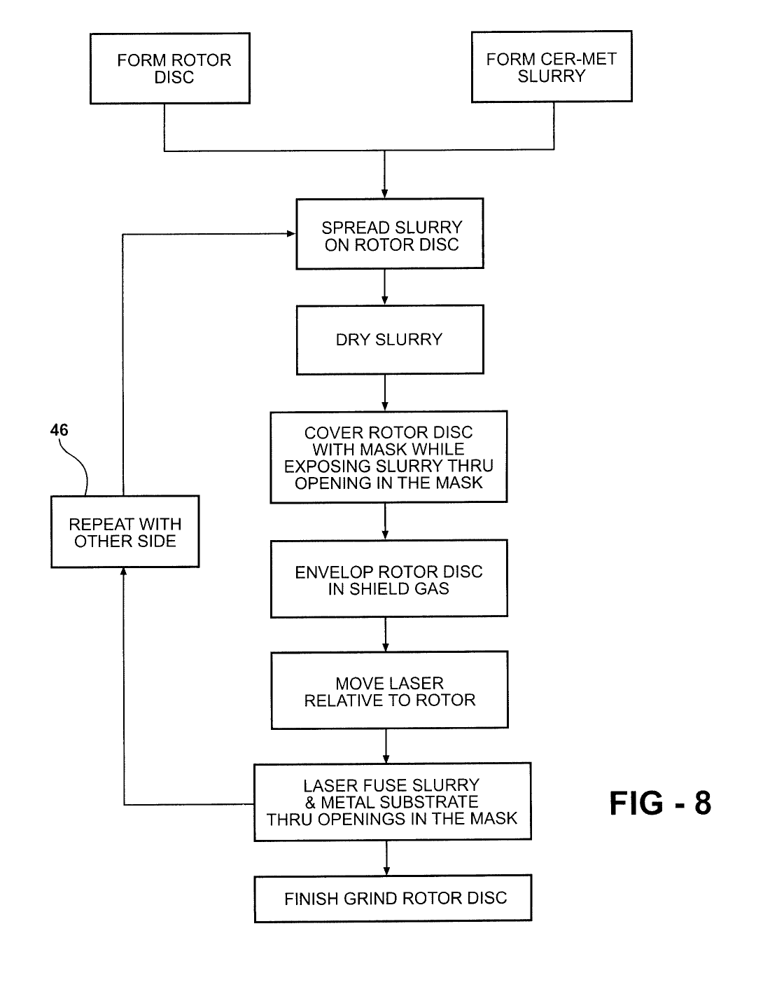

As shown in FIG. 8, function block 46 directs the process, as described above, to be repeated for the outboard friction surface 22. Although FIG. 8 suggests that the repetition occurs only after the inboard friction surface 20 has been laser fused, other sequences of events may be used so as to form predetermined areas 30 on both sides of the rotor 12. Thus, in another example, it may be preferred to spread slurry on both sides of the rotor disc 12, dry both sides, and then alternately laser fuse the friction surfaces 20, 22. Therefore, the sequence of events presented in FIG. 8 is but one example.

The subject method represents a substantial improvement in methods for enhancing the braking effectiveness, vibration attenuation and/or longevity of a vehicular brake rotor. The technique of covering at least a portion of the friction surface 20, 22 with a reflective mask 34 having at least one opening 38 therein so that a laser beam 40 can be focused through the opening 38 toward a ceramic-metallic slurry 32 without fear of irradiating unintended areas of the rotor disc 12 enables more precise and faster production opportunities. In the vehicular field, where components are typically mass produced in high volume production settings, this technique represents a practical solution and an enabling technology.

The foregoing invention has been described in accordance with the relevant legal standards, thus the description is exemplary rather than limiting in nature. Variations and modifications to the disclosed embodiment may become apparent to those skilled in the art and fall within the scope of the invention. Accordingly the scope of legal protection afforded this invention can only be determined by studying the following claims.

What is claimed is:

1. A method for enhancing the braking effectiveness of a vehicular brake rotor comprising the steps of:
forming an annular rotor disc from a metallic substrate and having inboard and outboard friction surfaces for engaging friction pads carried by a caliper;
forming a ceramic-metallic slurry;
spreading the slurry over at least a portion of one of the inboard and outboard surfaces;
fusing the slurry to the metallic substrate in a predetermined area of the rotor disc using a laser beam; and
prior to said fusing step, covering at least a portion of the friction surface with a reflective mask having an opening therein corresponding to the predetermined area on the friction surface to be fused, and said fusing step further including focusing the laser beam through the opening in the mask and toward the slurry exposed through the opening whereby the mask reflects the laser beam away from the rotor disc in areas not to be fused.

2. The method of claim 1, wherein said fusing step includes enveloping the predetermined area on the friction surface to be fused with a non-oxidizing shield glass.

3. The method of claim 1, wherein said fusing step includes energizing a diode laser above one kilowatt.

4. The method of claim 1, further including the step of finish machining the predetermined area on the friction surface following said fusing step.

5. The method of claim 1, further including the step of drying the slurry prior to said fusing step.

6. The method of claim 5, wherein said step of drying the slurry includes blowing hot air on the rotor disc.

7. The method of claim 5, wherein said step of drying the slurry includes placing the rotor disc in an oven.

8. The method of claim 1, wherein said step of forming the slurry includes suspending ceramic and metallic powders together with a binder in a liquid carrier.

9. The method of claim 8, wherein said step of suspending ceramic and metallic powders together with a binder in a liquid carrier includes selecting the ceramic powder from the group consisting of: Al₂O₃, MgZrO₃, Cr₃C₂, WC, Cr₂O₃, TiO₂, TiB₂, TiC, B₄C, SiC, and Si₃N₄.

10. The method of claim 8, wherein said step of suspending ceramic and metallic powders together with a binder in a liquid carrier includes selecting the metallic powder from combinations of the elements Cr, Co, Ni, Fe, Al, Mo, Y, Si, B and C.

11. The method of claim 8, wherein said step of forming the slurry includes adding a thickening agent to the slurry.

12. The method of claim 1, wherein said fusing step includes moving the laser beam relative to the rotor disc.

13. The method of claim 1, wherein said step of spreading the slurry includes screen-printing the slurry onto the rotor disc.

14. The method of claim 1, wherein said step of spreading the slurry includes spraying the slurry onto the rotor disc.

15. The method of claim 1, wherein said step of spreading the slurry includes painting the slurry onto the rotor disc.

16. The method of claim 1, wherein said step of spreading the slurry includes dipping the rotor disc into the slurry.

17. The method of claim 1, wherein said step of forming an annular rotor disc from a metallic substrate includes fabricating the rotor disc from a predominantly cast iron material.

18. The method of claim 1, wherein said step of forming an annular rotor disc from a metallic substrate includes fabricating the rotor disc from a predominantly aluminum alloy.

19. The method of claim 1, further including the step of forming the mask from a predominantly copper material.

20. The method of claim 19, wherein said step of forming the mask includes polishing at least one surface of the mask to a mirror-like finish for the laser beam away from the rotor disc in areas not to be fused.
